(19) United States
(12) Patent Application Publication
(10) Pub. No.: US 2008/0159427 A1
(43) Pub. Date: Jul. 3, 2008

(54) Apparatus and method for ranging in broadband wireless communication system

(75) Inventors: Hyon-Goo Kang, Suwon-si (KR); Joong-Keun Cho, Suwon-si (KR); Kwang-Sik Kim, Suwon-si (KR); Eun-Sil Hong, Suwon-si (KR); Sang-Mi Park, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/006,347

(22) Filed: Jan. 2, 2008

(30) Foreign Application Priority Data
Jan. 2, 2007 (KR) 2007-0000181

(51) Int. Cl. H04L 27/28; H04B 7/005

(52) U.S. Cl. 375/260; 455/69

(57) ABSTRACT

Provided is an apparatus and method for ranging in a broadband wireless communication system. In a method for communication of a base station, a received signal and ranging codes are correlated to detect codes. Feedback information for the detected codes is generated, and a ranging feedback message including the generated feedback information is generated. The ranging feedback message is physical-layer-encoded and the resulting data are broadcast. The base station combines and broadcasts data region allocation information and control information for ranging codes received from a plurality of mobile stations. Therefore, resources can be saved and a signalling process can be simplified.

### CROSS-REFERENCE TO RELATED APPLICATION(S) AND CLAIM OF PRIORITY

This application claims priority under 35 U.S.C. §119 to an application filed in the Korean Intellectual Property Office on Jan. 2, 2007 and allocated Serial No. 2007-181, the contents of which are incorporated herein by reference.

### TECHNICAL FIELD OF THE INVENTION

The present invention relates generally to an apparatus and method for ranging in a wireless communication system, and in particular, to an apparatus and method for processing a plurality of ranging codes in combination in a broadband wireless communication system.

### BACKGROUND OF THE INVENTION

As generally known in the art, communication systems have been primarily developed for voice communication services, but they are also evolving to provide data services and various multimedia services. However, conventional communication systems, which are mainly directed to providing voice communication services, still have a narrow data transmission bandwidth and require a high subscription fee. For these reasons, they cannot satisfy diversified user demands. Furthermore, in line with rapid development in the communication industry and ever-increasing demands on Internet services, it is important to provide communication systems capable of providing Internet services efficiently. As a result of these trends, broadband wireless communication systems for provide efficient Internet services have been proposed.

The broadband wireless communication systems use an Orthogonal Frequency Division Multiplexing (OFDM)/orthogonal Frequency Division Multiple Access (OFDMA) scheme. Thus, the broadband wireless communication systems can provide high-rate data transmission by transmitting physical channel signals using a number of subcarriers. The standardization of wireless access schemes of the broadband wireless communication systems is being conducted by Institute of Electrical and Electronics Engineers (IEEE), which is one of the international standardization organizations, particularly by the IEEE 802.16 standardization group.

Ranging is a kind of random access process in the broadband wireless communication system. The ranging process is used to set an accurate time/frequency offset between a base station (BS) and a mobile station (MS) and to correct the transmission (TX) power of a mobile terminal. The ranging process can be divided into initial ranging, periodic ranging, bandwidth request ranging, and handover ranging, depending on purposes.

A ranging code (or code set) used in each ranging is broadcast using an uplink channel descriptor (UCD) message. A mobile station performs a ranging process by transmitting an intended ranging code through a ranging region that is allocated using an uplink MAP (UL-MAP) message. Abase station corrects a time/frequency offset and the TX power of the mobile station by using the received ranging code, and performs a ranging process by allocating uplink resources, if necessary.

FIG. 1 a flow diagram illustrating an initial ranging process in a conventional broadband wireless communication system.

Referring to FIG. 1, a mobile station (MS) 10 selects a Code Division Multiple Access (CDMA) ranging code from a code set for initial ranging and transmits the selected CDMA ranging code to a base station (BS) 20 through a selected ranging slot in step 101.

Upon successful receipt of the CDMA ranging code, the base station 20 broadcasts a ranging response (RNG-RSP) message in response to the CDMA ranging code in step 103. Herein, the ranging response message includes ranging slot information (e.g., an OFDMA symbol number and a subchannel) for identification of the CDMA ranging code, ranging status information, and offset adjustment information (e.g., time, frequency and TX power collection values). Also, information about a region allocated the ranging response message is reported through a downlink resource allocation (DL-MAP) message.

Upon receipt of the ranging response message indicating that the ranging status is ‘Continue’, the mobile station 10 selects a CDMA ranging code from a code set for initial ranging and transmits the selected CDMA ranging code to a base station 20 through a periodic ranging region in step 105. That is, the mobile station 10 continues to attempt ranging.

Upon receipt of an initial CDMA ranging code, the base station 20 broadcasts a ranging response message including ‘Success’ status information in step 107. In step 109, the base station 20 allocates uplink resources through a CDMA_Allocation_IE( ) so that the mobile station 10 can transmit a ranging request (RNG-REQ) message.

As illustrated in FIG. 1, after the transmission of the ranging code, the mobile station 10 waits the ranging response message until expiration of a timer T3 with a set time. Thereafter, the mobile station 10 transmits a ranging request (RNG-REQ) message to a region allocated through the CDMA_Allocation_IE( ). In response to the ranging request message, the base station 20 transmits a ranging response message including a basic Connection IDentifier (CID) to the mobile station 10, thereby completing the initial ranging process. If the ranging status included in the ranging response message is ‘Continue’, the mobile station 10 must continue to attempt the initial ranging through the periodic ranging region.

The sizes of the messages exchanged for the process of FIG. 1 are described below.

The size of the DL-MAP_IE( ) transmitted in steps 103 and 107 (FIG. 1) is 60 bits, where 8-slot downlink resources must be used when the base station uses ‘QPSK ½ with 6 repetitions’ coding.

In the case of the RNG-RSP message transmitted in steps 103 and 107, Type/Length/Value (TLV) may change depending on the ranging status field values in the message. For example, if the ranging status field value is ‘0x01’ representing ‘Continue’, the size of the RNG-RSP message is 288 bits, where 36-slot downlink resources must be used when the base station uses ‘QPSK ½ with 6 repetitions’ coding for reception by all mobile stations within a cell area.

If the system performs Connection Admission Control (CAC) and cannot accommodate the mobile station, the ranging status field in the RNG-RSP message is set to ‘0x02’ representing ‘Abort’ and may include a ‘DL Frequency Override’ field. In this case, adjustment information is meaningless and thus may not be included in the message.

If the ranging status field value is ‘0x03’ representing ‘Success’, the size of the RNG-RSP message is 168 bits, where 21-slot downlink resources must be used when the base station uses ‘QPSK ½ with 6 repetitions’ coding for reception by all the mobile stations within the cell area.

The size of the CDMA Allocation IE( ) transmitted in step 107 (FIG. 1) is 60 bits, where 8-slot downlink resources must be used when the base station uses ‘QPSK ½ with 6 repetitions’ coding.

Thus, for the respective cases, the downlink resources used for one mobile station to attempt ranging can be summarized as follows:

(1) First-time-succeeding initial ranging or handover ranging: 288 bits

DL-MAP IE( ) for RNG-RSP: 60 bits

RNG-RSP(Ranging Status=Success): 168 bits

CDMA Allocation IE( ): 60 bits

(2) Second-time-succeeding initial ranging or handover ranging: 576 bits

DL-MAP IE( ) for RNG-RSP: 60 bits

RNG-RSP(Ranging status=Continue): 288 bits

DL-MAP IE( ) for RNG-RSP: 60 bits

RNG-RSP(Ranging Status=Success): 168 bits

CDMA Allocation IE( ): 60 bits

(3) First-time-succeeding periodic ranging: 228 bits

DL-MAP IE( ) for RNG-RSP: 60 bits

RNG-RSP(Ranging Status=success): 168 bits

(4) First-time-succeeding bandwidth request ranging: 60 bits

CDMA Allocation IE( ) : 60 bits.

The amount of the downlink resources is calculated as 60 bits because the RNG-RSP message may not be transmitted in case of the bandwidth request ranging.

The above resource amount is calculated in terms of one mobile station. In general, because a plurality of mobile stations attempt ranging at the same time, the resource amount used by the ranging is very large. The wireless communication system performs communication using limited resources. Thus, a technique for efficiently using radio resources is required. In particular, an effort to reduce resources used for signaling is required. In this context, it can be said that a ranging process performed separately for each of ranging codes is unreasonable in terms of system load and resource efficiency. What is therefore required is a scheme for processing a plurality of ranging codes in combination.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for ranging in a broadband wireless communication system.

Another object of the present invention is to provide an apparatus and method for processing a plurality of ranging codes in combination in a broadband wireless communication system.

Still another object of the present invention is to provide an apparatus and method for transmitting data region allocation information and control information for a plurality of ranging codes in combination in a broadband wireless communication system.

According to one aspect of the present invention, an apparatus of a base station in a wireless communication system includes: a code detector for correlating a received signal and ranging codes and outputting a correlation peak detection code number; a controller for generating feedback information for the detected codes from the code detector and generating a ranging feedback message including the generated feedback information; and a transmitter for encoding at physical-layer the ranging feedback message from the controller to broadcast the encoded data.

According to another aspect of the present invention, an apparatus of a mobile station in a wireless communication system includes: a receiver for receiving a ranging feedback message including feedback information for at least one ranging code after transmission of a ranging code; a message processor for interpreting the ranging feedback message received from the receiver and extracting feedback information about the ranging code from the ranging feedback message; and a controller for performing an operation according to the feedback information received from the message processor.

According to still another aspect of the present invention, a method for communication for a base station in a wireless communication system includes: correlating a received signal and ranging codes to detect codes; generating feedback information for the detected codes; generating a ranging feedback message including the generated feedback information; and encoding at physical-layer the ranging feedback message to broadcast the encoded data.

According to even another aspect of the present invention, a method for communication for a mobile station in a wireless communication system includes: transmitting ranging codes; receiving a ranging feedback message including feedback information for at least one ranging code; interpreting the received ranging feedback message and extracting feedback information about the ranging code from the ranging feedback message; and performing an operation according to the extracted feedback information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 a flow diagram illustrating an initial ranging process in a conventional broadband wireless communication system;

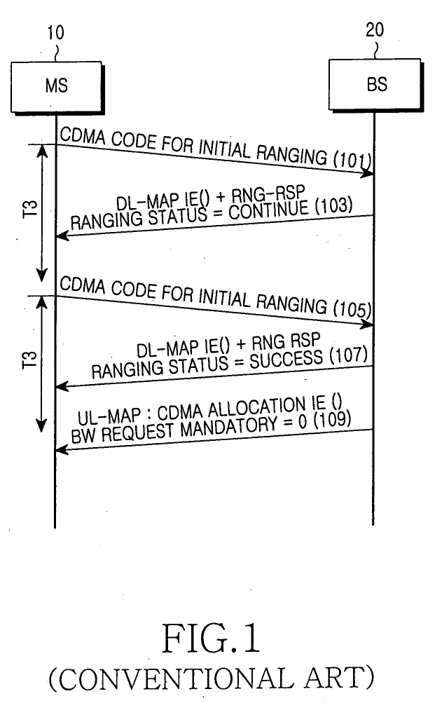

FIG. 2 is a flow diagram illustrating a procedure for processing ranging codes in combination in a broadband wireless communication system according to an embodiment of the present invention;

FIG. 3 is a flowchart illustrating a process for operation of a base station in the broadband wireless communication system according to an embodiment of the present invention;

FIG. 4 is a flowchart illustrating a process for operation of a mobile station in the broadband wireless communication system according to an embodiment of the present invention; and

FIG. 5 is a block diagram of the base station (or the mobile station) in the broadband wireless communication system according to an embodiment of the present invention.

### DETAILED DESCRIPTION OF THE INVENTION

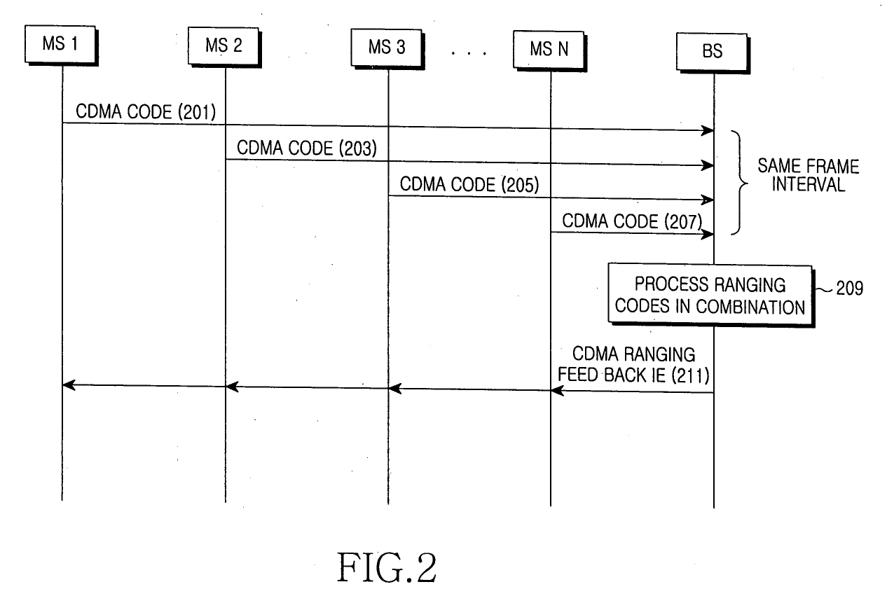

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may-be implemented in any suitably arranged wireless communication system.

The present invention is intended to provide a scheme for processing CDMA ranging in a broadband wireless communication system. In particular, the present invention is intended to provide a scheme for processing a plurality of ranging codes from mobile stations in combination.

The following description is made in the context of an OFDM or OFDMA broadband wireless communication system, to which the present invention is not limited.

FIG. 2 is a flow diagram illustrating a procedure for processing ranging codes in combination in a broadband wireless communication system according to an embodiment of the present invention.

Referring to FIG. 2, in order to avoid a collision, mobile stations (MSs) 1 through N, which attempts ranging, selects a ranging slot using a predetermined algorithm (e.g., a binary truncated exponent algorithm) and selects a ranging code (e.g., a CDMA code) from an intended code set. In steps 201 through 207, the mobile stations 1 through N transmit the selected ranging code to a base station (BS) through the selected ranging slot. Herein, it is assumed that the mobile stations attempt ranging in the same frame interval.

Upon receipt of the ranging codes, the base station processes the received ranging codes in combination in step 209. In detail, the base station generates feedback information for each ranging code and generates a ranging feedback message (e.g., CDMA Ranging Feedback IE) including the generated feedback information. The ranging feedback message may include ranging status information, uplink resource allocation information, and adjustment information (e.g., time, frequency and TX power correction values) for each ranging code. An example of the ranging feedback message is shown in Table 1. That is, the ranging feedback message may include feedback information (or response information) for at least one ranging code detected.

In step 211, the base station broadcasts the generated ranging feedback message to the mobile stations 1 through N. For example, the ranging feedback message is broadcast through DL-MAP.

Table 1 shows an example of the ranging feedback message (e.g., CDMA Ranging Feedback IE( )).

TABLE 1

| | Size | |
|---|---|---|
| Syntax | (bit) | Description |
| DIUC | 4 | DIUC = 2 |
| | | For example |
| | | 0-11: Different Burst Profiles |
| | | 12: CDMA Ranging Feedback |
| | | 13: Gap/PAPR Reduction |
| | | 14: Extended-2 DIUC |
| | | 15: Extended DIUC |
| Multi-frame Number Index | 2 | Identifies the Multi-frame in which the CDMA code, which this |
| | | message responds to, was transmitted. The 2 LSBs of the |
| | | Multi-frame number are used as the Multi-frame number index. |
| Frame Number Index | 3 | Identifies the frame in which the CDMA code, which this message |
| | | responds to, was transmitted. The 3 LSBs of the frame number are |
| | | used as the frame number index. |
| Number of Ranging Code Sets | 3 | 0b000 = 1 set is present in this message |
| | | 0b001 = 2 sets are present in this message |
| | | . . . |
| | | 0b111 = 8 sets are present in this message |
| for (i=0; i<Number of Ranging Code | | |
| set +1; i++){ | | |
| Type of Ranging Code Set | 2 | 0b00 = initial ranging |
| | | 0b01 = periodic ranging |
| | | 0b10 = BW request ranging |
| | | 0b11 = handover ranging |
| Ranging Region Index | 2 | Identifies the ranging region in which the CDMA code which this |
| | | message responds to, was transmitted. Ranging region index |
| | | corresponds to the position of ranging region in UL-MAOP or |
| | | broadcast message (for example, UCD). |
| Use of Ranging Code Bitmap | 1 | This field indicates use of the Ranging Code Bitmap-based format |
| Number of Ranging Codes | 3 | Identifies the number of ranging code in this Ranging Code Set |
| | | It shall be same the number of “1” bit in the Ranging Code Bitmap |
| | | if the bitmap is used. |
| if (Use of Ranging Code Bitmap | | |
| ==1){ | | |
| Ranging Code Bitmap | var | Ranging Code bit map |
| | | The length of this field is defined as the number of ranging codes in |
| | | the broadcasting message (for example, UCD) |
| | | If Type of Ranging Code Set = 0b00, the MSB of bitmap indicates |
| | | the starting number of initial ranging, (S mod 256), and the LSB of |
| | | bitmap indicates the ending number, (S + N −1 mod 256). |
| | | If Type of Ranging Code Set = 0b01, the MSB of bitmap indicates |
| | | the starting number of periodic ranging, (S + N mod 256), and the |
| | | LSB of bitmap indicates the ending number, (S + N + M −1 mod |
| | | 256). |
| | | If Type of Ranging Code Set = 0b10, the MSB of bitmap indicates |
| | | the starting number of BW request ranging, (S + N + M mod 256), |
| | | and the LSB of bitmap indicates the ending number, (S + N + M + L |
| | | −1 mod 256). |
| | | If Type of Ranging Code Set = 0b11, the MSB of bitmap indicates |
| | | the starting number of handover ranging, (S + N + M + L mod 256), |
| | | and the LSB of bitmap indicates the ending number, |
| | | (S + N + M + L + O −1 mod 256). |
| | | (refer to 8.4.7.3 Ranging Codes in 802.16e−2005) |
| Padding | var | Padding to reach nibble boundary |
| } | | |
| for (j=0; j<Number of Ranging | | |
| Codes; j++){ | | |
| if (Use of Raging Code | | |
| Bitmap ==0){ | | |
| Ranging code | 8 | Indicates the CDMA Code sent by the MS |
| } | | |
| Ranging status | 2 | Used to indicate whether the ranging code is received within |
| | | acceptable limits by BS. |
| | | 0b00 = reserved |
| | | 0b01 = continue |
| | | 0b10 = abort |
| | | 0b11 = success |
| Skip Optional Adjustment Bitmap | 4 | Bit#0: if set to 1, omit Timing Adjustment field |
| | | Bit#1: if set to 1, omit Power Level Adjust field |
| | | Bit#2: if set to 1, omit Offset Frequency Adjust field |
| | | Bit#3: if set to 1, omit DL Frequency Override field |
| UL Allocation Indicator | 2 | 0b00: No UL resource is allocated. |
| | | 0b01: 6 OFDMA slots is allocated. The MS shall transmit the BW |
| | | request header only and use the most robust FEC in the definition |
| | | of UCD (for example, QPSK1/2) and the repetition coding of 6. |
| | | 0b10: reserved |
| | | 0b11: UL allocation is appended. |
| if (skip Optional Adjustment Bitmap | | |
| : Bit#0==0){ | | |
| Timing Adjustment | 32 | TX timing offset adjustment (signed 32-bit). The amount of time |
| | | required to adjust MS transmission so the bursts will arrive at the |
| | | expected time instance at the BS. Units are PHY specific (The |
| | | timing adjust units shall be 1/4 modulation symbols). The MS |
| | | shall advance its burst transmission time if the value is negative |
| | | and delay its burst transmission if the value is positive. |
| } | | |
| if (Skip Optional Adjustment | | |
| Bitmap: Bit#1 ==0){ | | |
| Power Level Adjust | 8 | TX power offset adjustment (signed 8-bit, 0.25 dB) |
| } | | |
| If (Skip Optional Adjustment | | |
| Bitmap: Bit#1 == 0){ | | |
| Offset Frequency Adjust | 32 | TX frequency offset adjustment (signed 32-bit, unit: Hz) |
| | | Specifies the relative change in transmission frequency that the MS |
| | | is to make in order to better match the RAS. (This is |
| | | fine-frequency adjustment within a channel, not reassignment to a |
| | | different channel.) The MS shall increase its transmit frequency if |
| | | the value is positive and decrease its transmit frequency if the value |
| | | is negative. |
| } | | |
| if (Skip Optional Adjustment | | |
| Bitmap: Bit#3 ==0){ | | |
| DL Frequency override | 32 | Center frequency, in kHz, of new downlink channel where the MS |
| | | should redo initial ranging. |
| | | If this field is used, the Ranging Status value shall be set to 2. Shall |
| | | be used for licensed bands only. |
| } | | |
| if (UL Allocation | | |
| Indicator==0b11){ | | |
| Duration | 6 | Indicates the duration, in units of OFDMA slots, of the allocation. |
| UIUC | 4 | UIUC for transmission on the Allocated UL region |
| Repetition coding indication | 2 | Indicates the repetition code used inside the allocated burst. |
| | | 0b00 - No repetition coding |
| | | 0b01 - Repetition coding of 2 used |
| | | 0b10 - Repetition coding of 4 used |
| | | 0b11 - Repetition coding of 6 used |
| } | | |
| } | | |
| } | | |

As shown in Table 1, the ranging feedback message includes a plurality of information elements. For example, the ranging feedback message includes a Downlink Interval Usage Code (DIUC) for representing the ranging feedbackmessage, a Multi-frame Number Index and a Frame Number Index for identifying a code-receiving frame, a Number of Ranging Code Sets for indicating the number of ranging code sets present in the ranging feedback message, and information about each of the ranging code sets.

Also, for each ranging code set, the ranging feedback message includes a Type of Ranging Code Set, a Ranging Region Index, a Use of Ranging Code Bitmap, a Number of Ranging Codes for indicating the number of ranging codes detected for the ranging code set, and Ranging Code Bitmap according to the Use of Ranging Code Bitmap. Herein, bits of the ranging code bitmap corresponding to the detected codes are set to a predetermined value (e.g., 1). If the bitmap is not used, the ranging feedback message may include information about the detected ranging codes instead of the bitmap.

Also, for each of the detected ranging codes, the ranging feedback message includes Ranging Status information, Skip Optional Adjustment Bitmap for designating an adjustment item, a UL Allocation Indicator for indicating uplink resource allocation information allocated in case of ranging success, and detailed adjustment information about the adjustment item designated in the adjustment bitmap (e.g., Timing Adjustment, Power Level Adjust, Offset Frequency Adjust, and DL Frequency Override). If the UL Allocation Indicator is set to a predetermined value (e.g., 0b11), the ranging feedback message may further include uplink resource allocation information. Herein, the uplink resource allocation information may include a Duration for indicating the duration of the allocation, an Uplink Interval Usage Code (UIUC) for transmission on the allocated uplink region, and a Repetition Coding Indication for indicating the repetition code used inside the allocated burst.

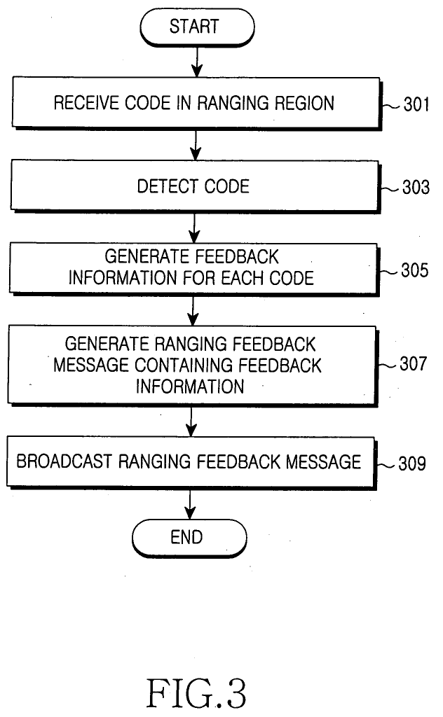

FIG. 3 is a flowchart illustrating a process for operation of a base station in the broadband wireless communication system according to an embodiment of the present invention.

Referring to FIG. 3, in step 301, the base station extracts a received signal from a ranging region. Herein, the ranging region includes ranging code regions such as an initial ranging region, a periodic ranging region, a bandwidth request ranging region, and a handover ranging region. The base station OFDM-demodulates the received signal to obtain frequency-domain data, and extracts the ranging code mapping data from the frequency-domain data.

In step 303, the base station performs code demodulation by correlating the extracted data and ranging codes. That is, the base station correlates the ranging codes and a signal received in each ranging slot, and obtains correlation peak detection codes.

In step 305, the base station generates feedback information for each of the detected codes. For example, the feedback information includes a Ranging Status information, an Offset Adjustment information (e.g., time, frequency and TX power correction values), and uplink resource allocation information allocated in case of ranging success.

In step 307, the base station generates a ranging feedback message including the feedback information for the detected codes. An example of the ranging feedback message is shown in Table 1.

In step 309, the base station broadcasts the generated ranging feedback message to mobile stations. For example, the ranging feedback message is transmitted through DL-MAP. For another example, the ranging feedback message is transmitted in a downlink data region and the region information is reported through a DL-MAP IE.

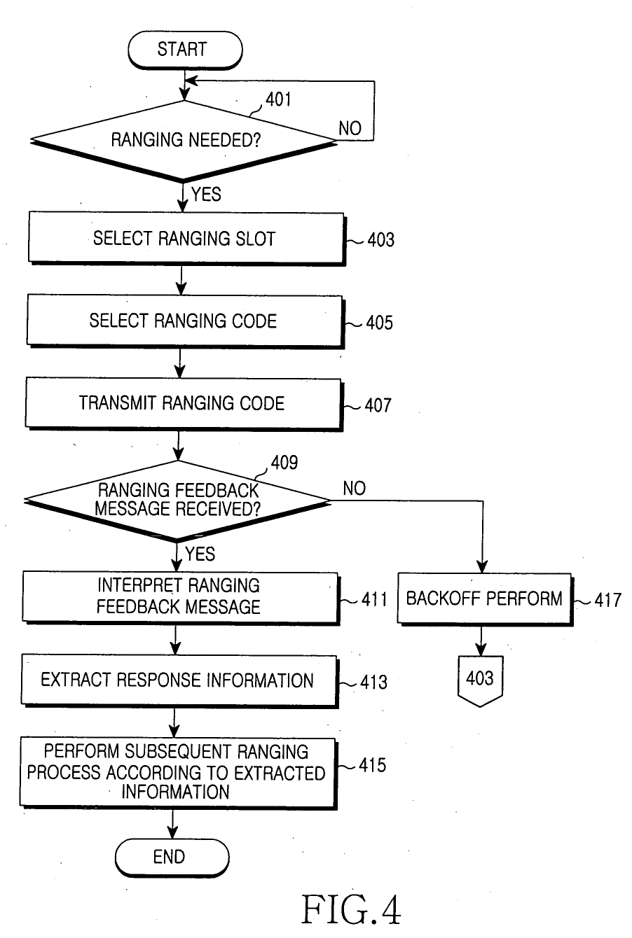

FIG. 4 is a flowchart illustrating a process for operation of a mobile station in the broadband wireless communication system according to an embodiment of the present invention.

Referring to FIG. 4, in step 401, the mobile station determines whether there is a need for ranging. Herein, the ranging may be one of CDMA code ranging processes such as initial ranging, periodic ranging, bandwidth request ranging, and handover ranging.

If there is a need for ranging, the process proceeds to step 403. In step 403, the mobile station selects one of slots within a ranging region allocated by the base station. In step 405, the mobile station selects one code from a ranging code set. In step 407, the mobile station transmits the selected ranging code to the base station by mapping the selected ranging code to the selected ranging slot.

In step 409, the mobile station determines whether a ranging feedback message is received in response to the ranging code. An example of the ranging feedback message is shown in Table 1. If the ranging feedback message is not received within a predetermined time, the process proceeds to step 417. In step 417, the mobile station performs a truncated binary exponential backoff algorithm. Thereafter, the process returns to step 403 in order to retransmit the ranging code. If the number of times of the retransmission of the ranging code reaches a predetermined value, the mobile station determines that the ranging has failed.

On the other hand, if the ranging feedback message is received within the predetermined time, the process proceeds to step 411. In step 411, the mobile station interprets the received ranging feedback message. At this point, the mobile station determines whether response information (e.g., feedback information) for its own ranging code is included in the ranging feedback message, by detecting a Multi-frame Number Index, a Frame Number Index, Type of Ranging Code Set, a Ranging Region Index, and a Ranging Code Bitmap.

If the response information for the ranging code is not included in the ranging feedback message, the mobile station discards the received ranging feedback message. On the other hand, if the response information for the ranging code is included in the ranging feedback message, the mobile station extracts the corresponding response information (e.g., ranging status information and offset adjustment information) in step 413.

In step 415, the mobile station performs an operation according to the extracted information. That is, the mobile station operates according to ranging status information or offset adjustment information (e.g., time, frequency and TX power correction values) included in the ranging feedback message. If the ranging status is ‘Success’, the mobile station detects uplink resources allocated through a UL Allocation Indicator included in the ranging feedback message, and transmits a message or a data burst through the allocation uplink resources.

The configurations of the base station and the mobile station will be described below. Since the base station and the mobile station have the same interface module (communication module), they have the same block configuration. Thus, the configurations of the base station and the mobile station will be described with reference to one block diagram.

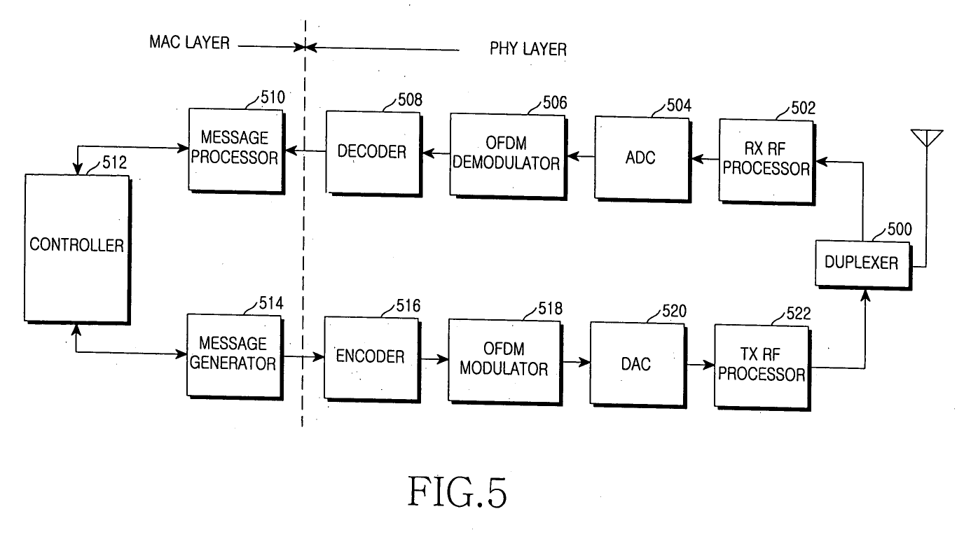

FIG. 5 is a block diagram of the base station (or the mobile station) in the broadband wireless communication system according to an embodiment of the present invention.

Referring to FIG. 5, the base station (or the mobile station) includes a duplexer 500, a receiving (RX) radio frequency (RF) processor 502, an analog-to-digital converter (ADC) 504, an OFDM demodulator 506, a decoder 508, a message processor 510, a controller 512, a message generator 514, an encoder 516, an OFDM modulator 518, a digital-to-analog converter (DAC) 520, and a transmitting (TX) RF processor 522. The following description is made on the assumption of using a Time Division Duplex (TDD)-OFDMA scheme. Also, the following description will focus on processing a control message (e.g., a MAC management message).

Based on a duplexing scheme, the duplexer 500 provides RX signals received from an antenna to the RX RF processor 502 and transmits TX signals received from the TX RF processor 522 through the antenna.

In an RX section, the RX RF processor 502 converts RF signals received through the antenna into baseband analog signals. The ADC 504 converts the analog signals received from the RX RF processor 502 into sampled data (digital signals). The OFDM demodulator 506 Fast Fourier Transform (FFT)-processes the sampled data to output frequency-domain data.

The decoder 508 selects data of desired subcarriers from the frequency-domain data. The decoder 508 demodulates and decodes the selected data in accordance with a predetermined Modulation and Coding Scheme (MCS) level.

The message processor 510 processes a control message received from the decoder 508 and provides the processing results to the controller 512. According to the present invention, the message processor 510 extracts a variety of data from the received control message and provides the extracted data to the controller 512.

The controller 512 performs processing according to the data received from the message processor 510 and provides the processing results to the message generator 514. The message generator 514 generates a message using a variety of data received from the controller 512 and outputs the generated message to the encoder 516 of a physical layer.

The encoder 516 encodes and modulates the data received from the message generator 514 in accordance with a predetermined MCS level. The OFDM modulator 518 Inverse Fast Fourier Transform (IFFT)-processes the data received from the encoder 516 to output sampled data (OFDM symbols). The DAC 520 converts the sampled data into analog signals. The TX RF processor 522 converts the analog signal received from the DAC 520 into an RF signal and transmits the RF signal through the antenna.

In the above-described configuration, the controller 512 serves as a protocol controller to control the message processor 510 and the message generator 514. The controller 512 can perform the functions of the message processor 510 and the message generator 514. Although separate units are provided for respective functions of the controller 512, the controller 512 can perform all or some of the functions instead of such separate units.

The operations of the base station and the mobile station will now be described with reference to the configuration of FIG. 5.

First, a description will be given of the operation of the base station. Although not illustrated, a ranging code detector extracts ranging signal mapping subcarrier values from subcarrier values received from the OFDM demodulator 506, and performs code detection by multiplying the extracted subcarrier values by ranging codes. That is, the ranging code detector correlates the ranging codes and a signal received in each ranging slot, and provides a correlation peak detection code number to the controller 512.

The controller 512 generates feedback information for each of the detected codes and provides the feedback information to the message generator 514. For example, the feedback information includes Ranging Status information, Adjustment information (e.g., time, frequency and TX power correction values), and uplink resource allocation information allocated in case of ranging success.

The message generator 514 generates a ranging feedback message using the feedback information for the detected codes and provides the generated ranging feedback message to the encoder 516 of the physical layer. The ranging feedback message is processed into the format transmittable in the physical layer prior to broadcast through the antenna.

A description will be given of the operation of the mobile station. Although not illustrated, a ranging code detector selects one code from a ranging code set, and maps the selected ranging code to a selected ranging slot. Thereafter, the OFDM modulator 518 IFFT-processes the ranging code mapped to the ranging slot, and generates an OFDM symbol by inserting a guard interval into the sample data resulting from the IFFT processing. The generated OFDM symbol is transmitted through the antenna via the DAC 520 and the TX RF processor 522. In response to the ranging code, the base station transmits the ranging feedback message to the mobile station.

The message processor 510 analyzes a control message received from the base station, and provides the analysis results to the controller 512. According to the present invention, if a ranging feedback message shown in Table 1 is received, the mobile station determines whether response information for the ranging code is present in the ranging feedback message. If the response information is present, the message processor 510 extracts the response information from the ranging feedback message and provides the extracted information to the controller 512.

The controller 512 performs an operation corresponding to the information received from the message processor 510. For example, the controller 512 operates according to the ranging status information or the offset adjustment information (time, frequency and TX power correction values) included in the ranging feedback message. Also, if the ranging status is ‘Success’, the controller 512 detects uplink resources allocated through the UL Allocation Indicator included in the ranging feedback message, and transmits a message or a data burst through the allocated uplink resources.

The resource amount for the ranging process according to the present invention and the resource amount for the conventional ranging process are compared as follows:

The comparison is made in terms of downlink resources used for a ranging code of one mobile station. The comparison is made assuming that the number of ranging codes for each ranging type is 4.

(1) First-time-succeeding initial ranging or handover ranging

Conventional method: 288 bits

Present invention: 44 bits (85% reduction).

(2) Second-time-succeeding initial ranging or handover ranging

Conventional method: 576 bits

Present invention: 160 bits (74% reduction).

Herein, the calculation is made assuming that the ranging status is ‘Continue’ and thus all of the timing, the TX power and the offset frequency must be adjusted.

(3) First-time-succeeding periodic ranging

Conventional method: 288 bits

Present invention: 32 bits (86% reduction)

Herein, the calculation is made excluding downlink resources because they are not allocated in case of the periodic ranging.

(4) First-time-succeeding bandwidth request ranging

Conventional method: 60 bits

Present invention: 32 bits (47% reduction)

Herein, the calculation is made excluding an RNG-RSP message because it may not be transmitted in case of the bandwidth request ranging.

The above comparison is made considering one mobile station. When a plurality of mobile stations is considered, the resource efficiency can be further increased.

In the above embodiment, the ranging feedback message includes feedback information about all the ranging codes. In another embodiment, a ranging feedback message may be used for each type of ranging.

As described above, the base station combines and broadcasts data region allocation information and control information for ranging codes received from a plurality of mobile stations. Therefore, resources can be saved and a signaling process can be simplified.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus of a base station in a wireless communication system, the apparatus comprising:
a code detector for correlating a received signal and ranging codes and outputting a correlation peak detection code number;
a controller for generating feedback information for the detected codes from the code detector and generating a ranging feedback message including the generated feedback information; and
a transmitter for physical-layer-encoding the ranging feedback message from the controller to broadcast the physical-layer-encoded data.

2. The apparatus of claim 1, wherein the feedback information includes at least one of ranging status information, offset adjustment information, new frequency channel information, and uplink resource allocation information.

3. The apparatus of claim 2, wherein the offset adjustment information includes at least one of timing adjustment information, frequency adjustment information, and TX power adjustment information.

4. The apparatus of claim 1, wherein the ranging feedback message includes at least one of message identification, frame identification, the number of ranging code sets, a type of a ranging code set, a ranging region index, information about detected ranging codes, and feedback information of the detected ranging codes.

5. The apparatus of claim 4, wherein the feedback information includes at least one of ranging status information, timing adjustment information, frequency adjustment information, TX power adjustment information, new frequency channel information, and uplink resource allocation information.

6. The apparatus of claim 1, wherein the ranging feedback message includes information on at least one of initial ranging, periodic ranging, bandwidth request ranging, and handover ranging.

7. The apparatus of claim 1, wherein the ranging feedback message is broadcast through a MAP region.

8. The apparatus of claim 1, wherein the transmitter comprises:
an encoder for encoding/modulating the ranging feedback message;
an OFDM modulator for OFDM-modulating the modulated data from the encoder
a digital-to-analog converter for converting the ODFM modulated data from the OFDM modulator into an analog baseband signal; and
an RF processor for converting the analog baseband signal from the digital-to-analog converter into an RF signal

9. An apparatus of a mobile station in a wireless communication system, the apparatus comprising:
a receiver for receiving a ranging feedback message including feedback information for at least one ranging code after transmission of the ranging code by a transmitter;
a message processor for interpreting the ranging feedback message received from the receiver and extracting the feedback information about the ranging code from the ranging feedback message; and
a controller for performing an operation according to the feedback information received from the message processor.

10. The apparatus of claim 9, wherein the ranging feedback message includes at least one of message identification, frame identification, the number of ranging code sets, a type of a ranging code set, a ranging region index, information about detected ranging codes, and feedback information of the detected ranging codes.

11. The apparatus of claim 10, wherein the feedback information includes at least one of ranging status information, timing adjustment information, frequency adjustment information, transmission (TX) power adjustment information, new frequency channel information, and uplink resource allocation information.

12. The apparatus of claim 9, wherein the ranging code is one of an initial ranging code, a periodic ranging code, a bandwidth request ranging code, and a handover ranging code.

13. The apparatus of claim 9, wherein the ranging feedback message is received through a MAP region.

14. The apparatus of claim 9, wherein if the feedback information includes offset adjustment information, the controller performs an operation for adjusting at least one of uplink timing, frequency and TX power according to the offset adjustment information.

15. The apparatus of claim 9, wherein if the feedback information includes uplink resource allocation information, the controller performs an operation for transmitting a message or a data burst through an allocated uplink resource.

16. The apparatus of claim 9, wherein the receiver comprises:
an RF processor for converting a received RF signal into a baseband analog signal;
an analog-to-digital converter for converting the analog signal from the RF processor into sample data;
an OFDM demodulator for OFDM-demodulating the sample data received from the analog-to-digital converter; and
a decoder for extracting the ranging feedback message from the OFDM-demodulated data received from the OFDM demodulator and demodulating/decoding the extracted ranging feedback message.

17. A method for communication for a base station in a wireless communication system, the method comprising:
correlating a received signal and ranging codes to detect codes;
generating feedback information for the detected codes;
generating a ranging feedback message including the generated feedback information; and
physical-layer-encoding the ranging feedback message to broadcast the physical-layer-encoded data.

18. The method of claim 17, wherein the feedback information includes at least one of ranging status information, offset adjustment information, new frequency channel information, and uplink resource allocation information.

19. The method of claim 18, wherein the offset adjustment information includes at least one of timing adjustment information, frequency adjustment information, and transmission power adjustment information.

20. The method of claim 17, wherein the ranging feedback message includes at least one of message identification, frame identification, the number of ranging code sets, a type of a ranging code set, a ranging region index, information about detected ranging codes, and feedback information of the detected ranging codes.

21. The method of claim 20, wherein the feedback information includes at least one of ranging status information, timing adjustment information, frequency adjustment information, transmission power adjustment information, new frequency channel information, and uplink resource allocation information.

22. The method of claim 17, wherein the ranging feedback message includes information on at least one of initial ranging, periodic ranging, bandwidth request ranging, and handover ranging.

23. The method of claim 17, wherein the ranging feedback message is broadcast through a MAP region.

24. The method of claim 17, wherein the broadcasting comprises:
encoding/modulating the ranging feedback message;
mapping the modulated data to a predetermined resource to OFDM-modulate the mapped data; and
converting the OFDM-modulated data into an RF signal.

25. A method for communication for a mobile station in a wireless communication system, the method comprising:
transmitting a ranging code;
receiving a ranging feedback message including feedback information for at least one ranging code;
interpreting the received ranging feedback message and extracting the feedback information about the transmitted ranging code from the ranging feedback message; and
performing an operation according to the extracted feedback information.

26. The method of claim 25, wherein the ranging feedback message includes at least one of message identification, frame identification, the number of ranging code sets, a type of a ranging code set, a ranging region index, information about detected ranging codes, and feedback information of the detected ranging codes.

27. The method of claim 26, wherein the feedback information includes at least one of ranging status information, timing adjustment information, frequency adjustment information, transmission power adjustment information, new frequency channel information, and uplink resource allocation information.

28. The method of claim 25, wherein the ranging code is one of an initial ranging code, a periodic ranging code, a bandwidth request ranging code, and a handover ranging code.

29. The method of claim 25, wherein the ranging feedback message is received through a MAP region.

30. The method of claim 25, wherein performing the operation comprises:
if the feedback information includes offset adjustment information, performing an operation for adjusting uplink timing, frequency or transmission power according to the offset adjustment information; and
if the feedback information includes the uplink resource allocation information, performing an operation for transmitting a message or a data burst through anallocated uplink resource.

31. The method of claim 25, wherein receiving the ranging feedback message comprises:
converting a received RF signal into baseband sample data;
OFDM-demodulating the sample data to generate frequency-domain data;
extracting the ranging feedback message from the frequency-domain data; and
demodulating/decoding the extracted ranging feedback message.

32. A method for ranging in a broadband wireless communication system, the method comprising:
transmitting ranging codes from mobile stations to a base station; and
generating, at the base station, feedback information for each of the ranging codes received in a predetermined time period, generating a ranging feedback message including the generated feedback information, and broadcasting the generated ranging feedback message to the mobile stations.

33. The method of claim 32, wherein the ranging feedback message includes at least one of message identification, frame identification, the number of ranging code sets, a type of a ranging code set, a ranging region index, information about detected ranging codes, and feedback information of the detected ranging codes.

34. The method of claim 33, wherein the feedback information includes at least one of ranging status information, timing adjustment information, frequency adjustment information, transmission power adjustment information, new frequency channel information, and uplink resource allocation information.
